(19) United States
(12) Patent Application Publication
(10) Pub. No.: US 2025/0074500 A1
(43) Pub. Date: Mar. 6, 2025

(54) STEERING COLUMN ASSEMBLY FOR A VEHICLE

(71) Applicant: ZF Steering Systems Poland Sp. Z o.o., Czechowcie-Dziedzice (PL)

(72) Inventors: Michal Olszówka, Bielsko-Biala (PL); Marcin Komorowski, Bielsko-Biala (PL)

(21) Appl. No.: 18/819,560

(22) Filed: Aug. 29, 2024

(30) Foreign Application Priority Data
Sep. 1, 2023 (EP) 23461644.9
Sep. 15, 2023 (GB) 2314128.6

(51) Int. Cl. B62D 5/04

(52) U.S. Cl. CPC B62D 5/0454

(57) ABSTRACT

A steering column assembly (10) for a vehicle, comprises: an elongate steering column (20) rotatably mounted about a longitudinal axis (L) and configured for attachment of a steering wheel (A) at one end; a first gear (40) configured to rotate with the elongate steering column (20); a motor (80) having an output engaged with the first gear (40); and first and second bearings (50, 60) configured for rotational mounting of the elongate steering column (20) and located to one side of the first gear (40) along the longitudinal axis (L), wherein the first and second bearings (50, 60) are spaced from one another along the longitudinal axis (L).

### TECHNICAL FIELD

This invention relates generally to steering column assemblies for vehicles and in particular to such assemblies for use in steer-by-wire vehicles. More specifically, although not exclusively, this invention relates to steering column assembles, steer-by-wire steering systems comprising such steering column assemblies and to vehicles comprising such steering column assemblies. Steering column assemblies of the type used in steer-by-wire vehicles are typically formed as part of a torque feedback unit that is generally known as or forms part of a handwheel actuator or handwheel actuator system.

### BACKGROUND

In steer-by-wire arrangements, a steering wheel is connected to one end of a rotatably mounted steering column whose angular displacement is measured to generate a signal which is used to control the orientation of the steered wheels of the vehicle. The arrangement is commonly also provided with an electric torque motor connected to the steering column to provide a controlled amount of torque in the opposite direction to the torque applied by the driver, in order to provide a sensation of road feel to the driver. The electric torque motor generally forms part of a torque feedback unit.

The torque is applied to the steering column via a gear mounted on, and rotatable with, the steering column. It has been found that misalignment between the gear rotatable with the steering column and the output of the electric torque motor can lead to excessive component wear and eventual failure. Various support arrangements have been provided to the steering shaft and gear in an attempt to maintain correct alignment, but these are often difficult to assemble and require a large package volume.

It would be advantageous to provide a steering column assembly in which correct alignment is maintained between a gear rotatable with a steering column and an output of an electric torque motor whilst minimising the package volume.

It has been found that the aforementioned issues may be overcome by providing a steering column assembly in which a pair of bearings are provided on one side of the gear rotatable with the steering column.

### SUMMARY

In accordance with the present invention, a steering column assembly for a vehicle comprises:

an elongate steering column or shaft (hereinafter column) rotatably mounted about a longitudinal axis and configured for attachment of a steering wheel at one end;

a first gear configured to rotate with the elongate steering column;

a motor having an output engaged with the first gear; and

first and second bearings configured for rotational mounting of the elongate steering column and located to one side of the first gear along the longitudinal axis,

wherein the first and second bearings are spaced from one another along the longitudinal axis.

Advantageously, providing a pair of bearings located on the same side of the first gear rotatable with the steering column allows the position of the first gear relative to the worm gear(s) and/or worm shaft(s) to be controlled more easily. This ensures that correct alignment between the engaged gears is maintained such that friction and wear can be minimised.

Furthermore, the arrangement of the bearings relative to the first gear allows the overall package volume, and the overall number of components, of the steering column assembly to be reduced when compared with an arrangement in which the bearings are located on either side of the first gear.

Additionally, by arranging the bearings in this way, the manufacture of the steering column assembly is simplified.

The steering column assembly may be or may comprise a hand wheel actuator system.

The first gear and motor may form part of a torque feedback unit.

The steering wheel may otherwise be referred to as a hand wheel or a hand wheel actuator.

The steering column assembly may comprise a sensor or sensor module mounted or fixed to the elongate steering column. The sensor or sensor module may extend around the elongate steering column.

It will be appreciated that by providing a sensor or sensor module mounted to the elongate steering column, this eliminates the need for a separate sensor housing, thereby reducing the size of the overall steering column assembly. The sensor or sensor module may be located within a housing of the steering column assembly.

The first bearing and/or the second bearing may extend around the elongate steering column.

In an embodiment, the first gear is located between the ends of the elongate steering column. The first gear may be located between first and second ends of the elongate steering column. The first end may be an upper end. The second end may be a lower end. The first end may be configured for attachment of a steering wheel.

The second end may define or comprise an output shaft. The output shaft may form part of a or the torque feedback unit.

The first gear may be located part way along the elongate steering column. The first gear may be or may comprise a wheel gear.

The first and second bearings may be located between the first gear and an end of the elongate steering column opposite the end configured for attachment of a steering wheel.

The first and second bearings may be located between the first gear and a second end or lower end of the elongate steering column.

The first and/or second bearings may be configured to maintain or retain the position of the first gear along the longitudinal axis. The first and second bearings may operate together to maintain or retain the position of the first gear along the longitudinal axis.

In an embodiment the first bearing and/or second bearing may be or comprise an annular bearing. The annular bearing may be or comprise a roller bearing.

Each of the first and second bearings may be or comprise annular bearings.

In an embodiment, a diameter, e.g. inner diameter and/or outer diameter, of the first bearing is different than a diameter, e.g. inner diameter and/or outer diameter, of the second bearing.

The diameter, e.g. inner diameter and/or outer diameter, of the first bearing may be greater than the diameter, e.g. inner diameter and/or outer diameter, of the second bearing.

In an embodiment, a diameter, e.g. inner diameter and/or outer diameter, of the first bearing is equal to a diameter, e.g. inner diameter and/or outer diameter, of the second bearing.

The diameter, e.g. inner diameter and/or outer diameter, of the first bearing may be equal to the diameter, e.g. inner diameter and/or outer diameter, of the second bearing.

The first bearing may be located between the first gear and the second bearing.

Each of the first bearing and the second bearing may be received over an end of the elongate steering column. Each of the first bearing and the second bearing may be received over a lower end of the elongate steering column or the end of the elongate steering column opposite the end configured for attachment of a steering wheel.

The elongate steering column may comprise an annular step or shoulder. The first gear may be located between the annular step and the first bearing.

In an embodiment, a portion of the first bearing abuts a portion of the first gear such that the first gear is retained or captivated between the annular step and the first bearing.

The first bearing and/or second bearing may retain the first gear on the elongate steering column.

The elongate steering column may comprise a further annular step or shoulder. The second bearing may abut the further annular step.

The steering column assembly may comprise an annular retaining ring, an annular retaining nut or a nut (hereinafter annular retaining ring).

The annular retaining ring may be located between the second bearing and the lower end or the end of the elongate steering column opposite the end configured for attachment of a steering wheel.

The annular retaining ring may be received over an end of the elongate steering column.

The annular retaining ring may be received over a lower end of the elongate steering column or the end of the elongate steering column opposite the end configured for attachment of a steering wheel.

The annular retaining ring may abut the second bearing.

The steering column assembly may comprise a housing.

The first gear, first bearing and/or second bearing may be enclosed within the housing.

The first gear, first bearing and/or second bearing may be located within the housing.

In an embodiment, the first and second bearings are configured to provide support to the first gear within the housing along or in the direction of the longitudinal axis.

The first bearing and the second bearing may each be positioned or located between the elongate steering column and the housing.

An inner surface of each bearing may contact an outer surface of the elongate steering column and an outer surface of each bearing may contact an internal surface of the housing.

The first bearing may be a press-fit on the elongate steering column. The second bearing may be a press-fit within the housing. The first bearing and/or the second bearing may be received within a bearing carrier, e.g. within the housing.

The steering column assembly may comprise an end plate, and the sensor or sensor module may be located between the housing and the end plate. The elongate steering column may extend through the end plate, e.g. an aperture thereof.

The output from the motor may comprise a worm gear or worm shaft engaged with the first gear.

The steering column assembly may comprise a pair of motors. Each motor may have a respective motor output. Each output may comprise a respective worm gear, engaged with the first gear. The pair of motors and/or respective worm gears may form part of a or the torque feedback unit.

The steering column assembly may comprise a controller, for example an electronic control unit (ECU), configured to control the motor output of each motor.

The steering column assembly may comprise first and second worm gears. Each of the first and second worm gears may be driven by a respective motor, wherein the worm gears are each engaged with the first gear.

In an embodiment, the worm gears and are engaged with the first gear at diametrically opposed sides thereof.

The worm gear(s) and first gear may form or may comprise a worm and wheel gearset.

In an embodiment, the first gear is a press-fit on the elongate steering column or the output shaft.

In an embodiment, the first gear is over moulded on the elongate steering column or the output shaft.

The elongate steering column may comprise a plurality of parts or sections. The elongate steering column may comprise two parts or sections.

The first gear, first bearing and/or second bearing may be located on a first part or section. The first part or section may be or may comprise an output shaft. The output shaft may form part of a or the torque feedback unit.

The elongate steering column assembly may comprise a second part or section connectable with the first part or section. The first part or section may be connectable with the first part or section by a torsion bar. The first part or section may be threadedly connectable with the second part or section. The second part or section may be or may comprise an input shaft.

The second part or section may be configured for attachment of a steering wheel or hand wheel actuator at a free end.

The first part or section may comprise the annular retaining ring.

The first part or section of the elongate steering column may be enclosed or located within the housing. The housing may form part of a or the torque feedback unit.

A further aspect of the invention provides a steering column assembly for a steer-by-wire vehicle, as described above.

A further aspect of the invention provides a steer-by-wire steering system comprising a steering column assembly as described above.

A further aspect of the invention provides a vehicle comprising a steering column assembly as described above or a steer-by-wire steering system as described above.

It should also be noted that the housing receives multiple component parts of the assembly including the motors, the first and second gears, the worm gears, the bearings, the torque sensor and the housing for the MTL, which are then secured by covers which are either separate or included as part of the components. This simplifies the design by removing the complexity of assembling several component housings. It also facilitates the correct location of all parts within the assembly.

For the avoidance of doubt, any of the features described herein apply equally to any aspect of the invention.

Another aspect of the invention provides a computer program element comprising and/or describing and/or defining a three-dimensional design for use with a simulation means or a three-dimensional additive or subtractive manufacturing means or device, e.g. a three-dimensional printer or CNC machine, the three-dimensional design comprising an embodiment of the steering column assembly described above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the invention, whether or not these are expressly claimed. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments of the invention will now be described by way of example only with reference to the accompanying drawings in which:

FIG. 1 is a schematic illustration of a steer-by-wire steering system in accordance with the present invention;

FIG. 2 is a side cross-sectional view of a steering column assembly in accordance with an embodiment of the present invention taken through the longitudinal axis of the elongate steering column;

FIG. 3 is a side cross-sectional view of the arrangement of FIG. 2 taken through the longitudinal axis of the elongate steering column; and

FIG. 4 is a side cross-sectional view of a steering column assembly in accordance with another embodiment of the present invention taken through the longitudinal axis of the elongate steering column.

### DESCRIPTION

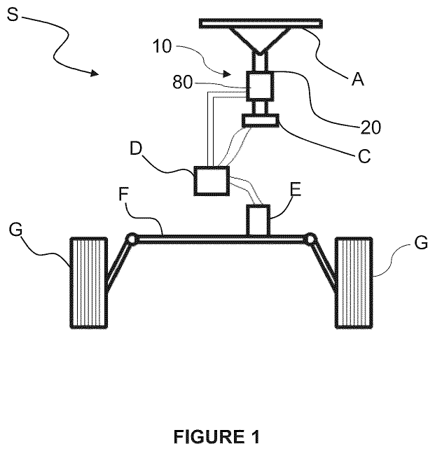

FIG. 1 illustrates a steer-by-wire system S for a vehicle incorporating a steering column assembly or hand wheel actuator system 10 (hereinafter steering column assembly) in accordance with the present invention. The steer-by-wire system S includes a handwheel actuator, in the form of a steering wheel or hand wheel actuator A (hereinafter steering wheel), to allow a driver of the vehicle to provide an input steering command. The steering wheel A is connected to an end of an elongate steering column or shaft 20 (hereinafter column).

A steering input applied through the steering wheel A is measured by a steering sensor forming part of the steering column assembly, shown schematically at C in FIG. 1. A signal representative of the steering input (i.e. the rotation of the steering wheel A and steering column 20) is transmitted from the sensor C to an electronic control unit (ECU) D which, in turn, controls a steering axle actuator E, for example a front axle actuator (FAA). The steering axle actuator E applies the steering input to the steering axle F, and therefore steers the steered wheels G as a function of the rotational position of the steering wheel A.

The electronic control unit D is also configured to supply a current to a torque feedback motor 80 connected to the elongate steering column 20 and which applies a torque in the opposite direction to the torque applied at the steering wheel A in order to provide a sensation of “road feel” to the driver. The torque feedback motor 80 forms part of a torque feedback unit (TFU) in this embodiment.

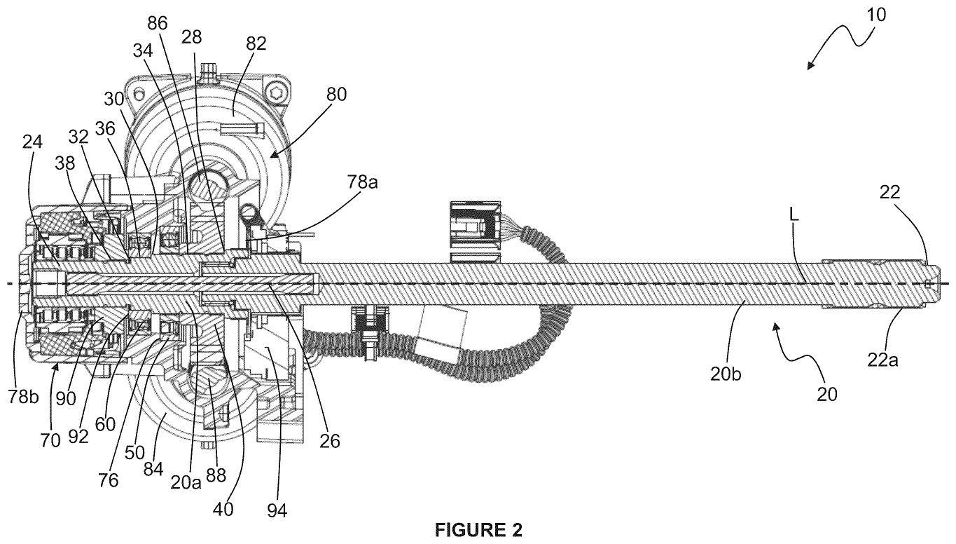

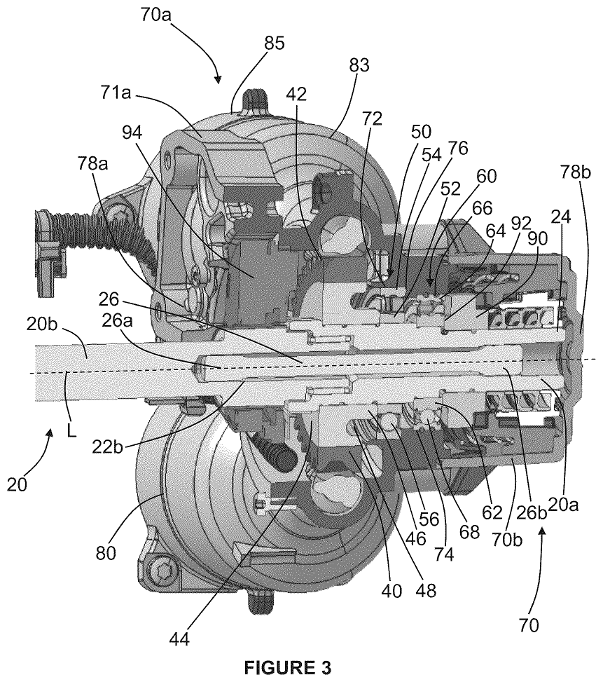

FIGS. 2 and 3 illustrate a first variant of a steering column assembly 10 which forms part of the steer-by-wire steering system S of FIG. 1. The steering column assembly 10 comprises an elongate steering column 20 mounted for rotation about its longitudinal axis L, and having an first end 22 with a connection feature 22a for attachment of a steering wheel A (FIG. 1) and a second end 24 opposite the first end 22. A first gear 40 is located between the first and second ends 22, 24 and is configured to rotate with the elongate steering column 20. The first gear 40 may be otherwise known as a wheel gear.

As will be described in greater detail below, the first gear 40 is in engagement with the output each of two identical torque feedback motors 80 that are operable to apply a torque in the opposite direction to the torque applied by the steering wheel A. A first bearing 50 and a second bearing 60 each extend around the elongate steering column 20 and are located between the first gear 40 and the second end 24.

As will be described in greater detail below, the bearings 50, 60 support the rotation of the elongate steering column 20 and maintain the position of the first gear 40 in the direction of the longitudinal axis L within a housing 70. By maintaining the position of the first gear 40, correct engagement between the first gear 40 and the output of the torque feedback motor 80 can be maintained, which can help to minimise component friction and wear.

The elongate steering column 20 is formed of two sections, a first section 20a and a second section 20b connected together by a torsion bar 26 having a pair of opposed externally splined heads 26a, 26b. Each of the splined heads 26a, 26b is press-fit within a respective plain recess of the first section 20a and the second section 20b. As will be described in greater detail below, each of the first gear 40, first bearing 50 and second bearing 60 are located on the first section 20a which is a hollow tubular section that extends to the second end 24 which is located within the housing 70. The first section 20a may be or may comprise an output shaft (OPS) in this embodiment.

The second section 20b is a solid rod in this embodiment having a plain recess 22b extending in the direction of the longitudinal axis L at its lower end, opposite the first end 22.

The first section 20a includes a first radially extending annular step or shoulder 28, a second radially extending annular step or shoulder 30 and a third radially extending annular step or shoulder 32 (hereinafter annular steps) spaced from one another consecutively along the longitudinal axis L. The annular steps 28, 30, 32 each face the second end 24 and provide a stepped profile along the first section 20a of the elongate steering column 20 such that the outer diameter thereof decreases in the towards the second end 24.

In particular, a first portion 34 having a first outer diameter is located between the annular steps 28, 30, a second portion 36 have a second outer diameter less than the first outer diameter is located between the annular steps 30, 32 and a third portion 38 having a third outer diameter less than the second outer diameter is located between the third annular step 32 and the second end 24. The second portion 36 is shorter in the direction of the longitudinal axis L than either the first portion 34 or the third portion 38.

The first gear 40 is received over the second end 24 and is a press-fit on the first portion 34 of the elongate steering column 20 until it abuts the first annular step 28. The first gear 40 has a plurality of teeth 42 arranged around a circumference thereof that are in engagement with the output of the torque feedback motor 80. The first gear 40 also includes a radially extending planar abutment surface 44 on an upper side that abuts the first annular step 28 and a longitudinally extending inner collar 46 in contact with the first portion 34. The abutment surface 44 extends radially beyond the first annular step 28, and they operate together to prevent movement of the first gear 40 along the longitudinal axis L beyond the first annular step 28 towards the first end 22.

An annular recess 48 is provided on a lower side of the first gear 40 and radially outward of the inner collar 46.

The first bearing 50 is an annular bearing and is located between the first gear 40 and the second bearing 60. The first bearing 50 is received over the second end 24 and has an inner race 52 that is a press-fit on the first portion 34 of the elongate steering column 20. An upper side of the inner race 52 abuts a free end of the inner collar 46 so as to retain the first gear 40 between the first annular step 28 and the first bearing 50. A radially outer surface of an outer race 54 contacts a first inner surface 72 of the housing 70 and a lower side of the outer race 54 contacts a shoulder 76 adjacent the first inner surface 72 of the housing 70. The inner race 52 and outer race 54 together contain a plurality of spherical bearings 56 to facilitate supported rotation of the first section 20a relative to the housing 70.

The second bearing 60 is also an annular bearing and is located between the first bearing 50 and the second end 24 of the elongate steering column 20. The second bearing 60 is received over the second end 24 has an inner diameter that is less than the inner diameter of the first bearing 50. The second bearing 60 is spaced from the first bearing 50 along the longitudinal axis L and has an inner race 62 mounted on the second portion 36 of the elongate steering column 20 and that abuts the second annular step 30. A radially outer surface of an outer race 64 is a press-fit within a second inner surface 74 of the housing 70 and includes a pair of O-rings 66. It will be appreciated that the O-rings 66 may be optional.

In a similar manner to the first bearing 50, the inner race 62 and outer race 64 together contain a plurality of spherical bearings 68 to further facilitate supported rotation of the first section 20a relative to the housing 70. The inner race 62 is longer in the direction of the longitudinal axis L than the second portion 36 of the elongate steering column 20 such that a portion of the second bearing 60 overhangs the third annular step 32.

An annular retaining ring 90 is received over the second end 24 and is press-fit on the third portion 38 of the first section 20a between the second bearing 60 and the second end 24. The annular retaining ring 90 has an annular abutment surface 92 at an upper end that abuts a lower surface of the inner race 62 of the second bearing 60 such that the second bearing 60 is retained between the second annular step 30 and the annular retaining ring 90.

A pair of identical electric motors 82, 84 each have a respective identical motor output shaft driven directly by the respective motor 82, 84. Each output shaft has a respective output worm gear 86, 88 that extend with their longitudinal axes parallel to each other and rotatably mounted with respect to the housing 70. The worm gears 86, 88 are engaged with the first gear 40 at diametrically opposed sides thereof. Each of the motors 82, 84 is located within a motor housing 83 having an interface plate 85 for connection to a controller (not shown). The worm gears 86, 88 and the first gear 40 form a worm and wheel gearset in this embodiment, A controller (not shown), for example an electronic control unit (ECU), may be configured to control the motor output of each motor 82, 84.

The housing 70 encloses the first section 20a of the elongate steering column 20, the first gear 40 and the first and second bearings 50, 60. The housing 70 has an upper side 78a and a lower side 78b and is formed of two parts in this embodiment, including a main body 70a having an intermediate bearing carrier 71a and a generally cup-shaped end portion 70b. The first bearing 50 is positioned between the elongate steering column 20 and the main body 70a and contacts the first inner surface 72. The second bearing 60 is also positioned between the elongate steering column 20 and the main body 70a and is a press-fit within the second inner surface 74. The cup-shaped end portion 70b also comprises a mechanical travel limiter (MTL—not shown) configured limit the extent of rotation of the elongate steering column 20 from a straight ahead position.

A sensor module 94 is mounted on the second section 20b of the elongate steering column 20, between the first gear 40 and the first end 22 and is nested within a recess of the intermediate bearing carrier 71a. The sensor module 94 is configured to detect the rotation of the elongate steering column 20, in use.

It should be noted that the housing 70 receives multiple component parts of the assembly including the motors 82, 84, the gear 40, the worm gears 86, 88, the bearings 50, 60, the torque sensor (not shown) and the housing for the MTL (not shown), which are then secured by covers which are either separate or included as part of the components. This simplifies the design by removing the complexity of assembling several component housings. It also facilitates the correct location of all parts within the assembly.

In order to assemble the steering column assembly 10, the second bearing 60 is press-fit within the second inner surface 74 of the housing 70 from the lower side 78b with the cup-shaped end portion 70b removed. The first gear 40 and the first bearing 50 are press-fit on the first section 20a such that the first gear 40 is retained between the first annular step 28 and the first bearing 50. The elongate steering column 20, together with the attached first gear 40 and first bearing 50, is then received within the upper side 78a of the housing 70 such that the first gear 40 engages each of the worm gears 86, 88 and the lower side of the outer race 54 contacts the shoulder 76 of the housing 70. The second end 24 of the elongate steering column 20 is extended through the second bearing 60 from the upper side 78a of the housing 70. Finally, annular retaining ring 90 is received over the second end 24 from the lower side 78a of the housing 70 and is press-fit on the third portion 38 of the first section 20a between the second bearing 60 and the second end 24. The cup-shaped end portion 70b is then attached to the main body 70a in order to enclose the first section 20a of the elongate steering column 20, the first gear 40 and the first and second bearings 50, 60 within the housing 70.

In use, a steering input applied through the steering wheel A provides a torque to the elongate steering column 20. In order to provide a sensation of “road feel”, the torque feedback motor 80 provides a feedback torque to the elongate steering column 20 in the direction opposite to that of the steering input. The feedback torque is applied by rotation of the worm gears 86, 88 which, in turn, apply a torque to the first gear 40. Rotation of the first gear 40 results in rotation of the elongate steering column 20.

The rotation of the first section 20a of the elongate steering column 20 within the housing 70 is supported by each of the bearings 50, 60. Furthermore, the position of the first gear 40 along the longitudinal axis L is maintained by the interaction between the first and second bearings 50, 60, the housing 70 and the annular steps 28, 30, 32.

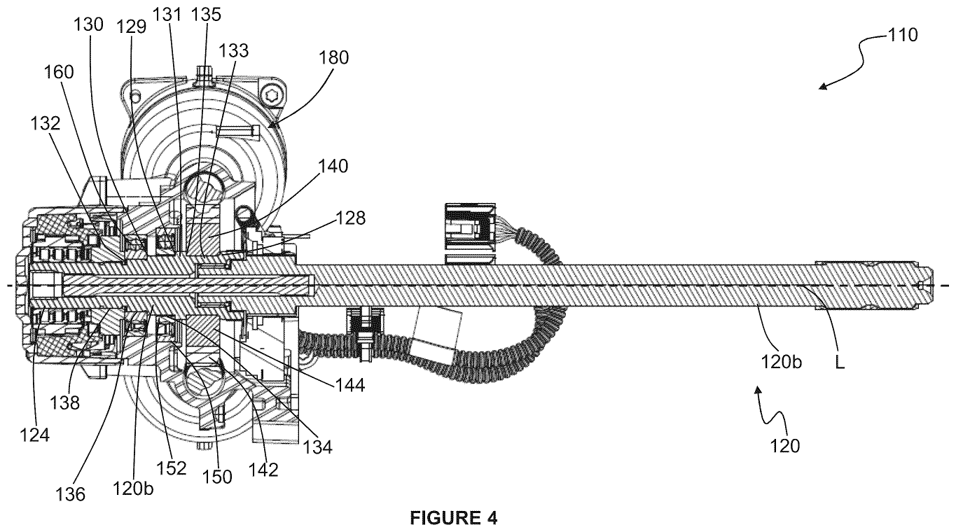

Referring now to FIG. 4, there is shown a second variant of a steering column assembly 110 which forms part of a steer-by-wire steering system S of FIG. 1 in accordance with the present invention. The arrangement of FIG. 4 is similar to the arrangement of FIGS. 2 and 3, wherein like features are denoted by like references incremented by ‘100’, only the differences will be described in detail and some detail may be omitted from FIG. 4.

The steering column assembly 110 differs from steering column assembly 10 in that the first gear 140 is over moulded on the elongate steering column 120. The first section 120a includes a first radially extending annular step or shoulder 128, a second radially extending annular step or shoulder 130 and a third radially extending annular step or shoulder 132, in a similar manner to the steering column assembly 10 of FIGS. 2 and 3. However, the steering column assembly 110 includes a fourth radially extending annular step or shoulder 129 located between the first annular step 128 and the second annular step 130. The fourth annular step 129 is defined by a radially extending annular rib 131. Furthermore, an annular recess 133 is defined between the first annular step 128 and an upper side 135 of the annular rib 131.

The annular steps 128, 129, 130 and 132 each face the second end 124 and provide a stepped profile along the first section 20a of the elongate steering column 20 such that the outer diameter thereof decreases in the towards the second end 24.

In particular, a first portion 134 having a first outer diameter is located between the annular steps 129, 130, a second portion 136 have a second outer diameter less than the first outer diameter is located between the annular steps 130, 132 and a third portion 138 having a third outer diameter less than the second outer diameter is located between the third annular step 132 and the second end 124. The second portion 136 is shorter in the direction of the longitudinal axis L than either the first portion 134 or the third portion 138. Furthermore, the outer diameter of the first section 120a within the recess 133 is the same as the first outer diameter of the first portion 134.

The first gear 140 is over moulded within the recess 129 and its position in the direction of the longitudinal axis L is maintained by the first annular step 128 and the upper side 135 of the annular rib 131. The first gear 140 has a plurality of teeth 142 arranged around a circumference thereof that are in engagement with the output of the torque feedback motor 180. The first gear 140 also comprises an annular base portion 144 having a generally square cross-sectional shape. The annular base portion 144 abuts the first annular step 128 and the upper side 135 of the annular rib 131. The annular base portion 144 extends radially beyond the first annular step 128 and the upper side 135 of the annular rib 131 to prevent movement of the first gear 140 in either direction along the longitudinal axis L.

The first bearing 150 is an annular bearing that is similar to the first bearing 50 of FIGS. 2 and 3, and is located between the first gear 140 and the second bearing 160. The first bearing 150 is received over the second end 124 and has an inner race 152 that is a press-fit on the first portion 134 of the elongate steering column 120. In this case, an upper side of the inner race 152 abuts the fourth radially extending annular step 129, rather than a portion of the first gear 140. The first bearing 150 is spaced from the first gear 140 by the radially extending annular rib 131.

The steering column assembly 120 is assembled in a similar manner to the steering column assembly 20, described above, with the difference in that the first gear 140 is over moulded on the first section 120a rather than a press-fit.

It will be appreciated by those skilled in the art that several variations to the aforementioned embodiments are envisaged without departing from the scope of the invention.

It will also be appreciated by those skilled in the art that any number of combinations of the aforementioned features and/or those shown in the appended drawings provide clear advantages over the prior art and are therefore within the scope of the invention described herein.

1. A steering column assembly for a vehicle, comprising:
an elongate steering column rotatably mounted about a longitudinal axis and configured for attachment of a steering wheel at one end;
a first gear configured to rotate with the elongate steering column;
a motor having an output engaged with the first gear; and
first and second bearings configured for rotational mounting of the elongate steering column and located to one side of the first gear along the longitudinal axis,
wherein the first and second bearings are spaced from one another along the longitudinal axis.

2. A steering column assembly according to claim 1, wherein the first gear is located between the ends of the elongate steering column, and the first and second bearings are located between the first gear and an end of the elongate steering column opposite the end configured for attachment of a steering wheel.

3. A steering column assembly according to claim 1, wherein each of the first and second bearings comprise annular bearings, and wherein the diameter of the first bearing is greater than the diameter of the second bearing.

4. A steering column assembly according to claim 3, wherein the first bearing is located between the first gear and the second bearing.

5. A steering column assembly according to claim 4, wherein the elongate steering column comprises an annular shoulder, and the first gear is located between the annular shoulder and the first bearing.

6. A steering column assembly according to claim 5, wherein a portion of the first bearing abuts a portion of the first gear such that the first gear is retained between the annular shoulder and the first bearing.

7. A steering column assembly according to claim 6, wherein the elongate steering column comprises a further annular shoulder, and the second bearing abuts the further annular shoulder.

8. A steering column assembly according to claim 4, comprising an annular retaining ring located between the second bearing and the end of the elongate steering column opposite the end configured for attachment of a steering wheel.

9. A steering column assembly according to claim 8, wherein the annular retaining ring abuts the second bearing.

10. A steering column assembly according to claim 1 comprising a housing and wherein the first gear, first bearing and second bearing are enclosed within the housing.

11. A steering column assembly according to claim 10, wherein the first and second bearings are configured to provide support to the first gear within the housing along the longitudinal axis.

12. A steering column assembly according to claim 10, wherein the first bearing and the second bearing are each positioned between the elongate steering column and the housing.

13. A steering column assembly according to claim 10, wherein the first bearing is a press-fit on the elongate steering column and the second bearing is a press-fit within the housing.

14. A steering column assembly according to claim 1, wherein the output from the motor comprises a worm gear engaged with the first gear.

15. A steering column assembly according to claim 1, comprising a pair of motors each having a respective motor output, wherein each output comprises a respective worm gear engaged with the first gear.

16. A steering column assembly according to claim 15, wherein the worm gears are engaged with the first gear at diametrically opposed sides thereof.

17. A steering column assembly according to claim 1, wherein the first gear is a press-fit on the elongate steering column.

18. A steering column assembly according to claim 1, wherein the first gear is over moulded on the elongate steering column.

19. A steering column assembly according to claim 1, wherein the elongate steering column comprises a plurality of sections, wherein the first gear, first bearing and second bearing are located on a first section.

20. A steering column assembly according to claim 19, wherein the elongate steering column assembly comprises a second section connectable with the first section, wherein the second section is configured for attachment of a steering wheel at a free end.

21. A steering column assembly according to claim 8, wherein the elongate steering column comprises a plurality of sections, wherein the first gear, first bearing and second bearing are located on a first section, the first section comprising the annular retaining ring.

22. A steering column assembly according to claim 10, wherein the elongate steering column comprises a plurality of sections, wherein the first gear, first bearing and second bearing are located on a first section, the first section of the elongate steering column being located within the housing.

23. A steering column assembly for a steer-by-wire vehicle according to claim 1.

24. A steer-by-wire steering system comprising a steering column assembly according to claim 1.

25. A vehicle comprising a steering column assembly as claimed in claim 1.
